(19) United States
(12) Patent Application Publication
(10) Pub. No.: US 2020/0002183 A1
(43) Pub. Date: Jan. 2, 2020

(54) INTEGRATED SYSTEM FOR CAPTURING CO2 AND PRODUCING SODIUM BICARBONATE (NAHCO3) FROM TRONA (NA2CO3 - 2H2O - NAHCO3)

(71) Applicant: UNIVERSIDAD DE SEVILLA, Sevilla (ES)

(72) Inventors: Ricardo CHACARTEGUI RAMIREZ, Sevilla (ES); Jose Antonio BECERRA VILLANUEVA, Sevilla (ES); Jose Manuel VALVERDE MILLAN, Sevilla (ES); Davide BONAVENTURA, Sevilla (ES)

(21) Appl. No.: 16/319,105

(22) PCT Filed: Jul. 13, 2017
(86) PCT No.: PCT/ES2017/000091

§ 371 Date: Jan. 18, 2019

(30) Foreign Application Priority Data
Jul. 19, 2016 (ES) P201600616

(51) Int. Cl. C01D 7/10; B01D 53/81; B01D 53/62

(52) U.S. Cl. CPC C01D 7/10; B01D 53/81; B01D 2257/504; B01D 2251/304; B01D 2251/606; B01D 53/62

(57) ABSTRACT

The present invention presents an integrated system for the production of Na₂HCO₃ from CO₂ captured from industries or power plants by means of a dry carbonate process starting from trona as raw material (Na₂CO₃—NaHCO₃-2H₂O) and converting it into sodium carbonate (Na₂CO₃). The optimized integration of the unit allows coupling the system with renewable energies at medium temperatures below 220° C., such as biomass or medium temperature solar thermal energy systems. The use of this invention integrated in a CO₂ emitting plant results in a global system of almost zero CO₂ emissions, being able to meet the heat requirements of the global integrated system, minimizing the energy consumption of the CO₂ capture system and conversion to bicarbonate. This optimized integration reduces the energy and economic penalty of integrating the CO₂ capture system and conversion to value-added chemical.

### TECHNICAL FIELD

The invention falls within the technical sector of CO₂ capture and storage (CCS), specifically with regard to CO₂ capture in power plants and industrial processes and its subsequent use (CCU) for the production of chemicals of industrial interest. This invention integrates the processes of CO₂ capture and production of sodium bicarbonate with the support of renewable energy, biomass or solar energy at medium temperature (<220° C.), resulting in a global system of almost zero emissions with a reduced energy penalty and low cost.

### STATE OF THE ART

CO₂ capture and storage has a great growth potential on a global scale due to the urgent need to reduce greenhouse gas emissions in order to mitigate global warming. The CO₂ capture processes developed in recent years at research and development (R&D) level have as main objectives the reduction of their costs and their energy requirements, so as to reduce or eliminate the energy and economic penalties associated with the integration of CO₂ capture systems. Currently, the only commercially available post combustion CO₂ capture technology is based on the chemical absorption of CO₂ by amines [1].

The process of CO₂ capture by dry sodium carbonate (dry carbonation process) is based on the chemical adsorption of CO₂ into sodium carbonate. By adsorption the sodium carbonate (Na₂CO₃) is converted to sodium bicarbonate (NaHCO₃) or an intermediate salt (Na₂CO₃-3NaHCO₃) by chemical reaction with CO₂ and steam [2]. The sorbent regenerates back to its carbonate form (Na₂CO₃) when heated, thus releasing an almost pure CO₂ flow after steam condensation. CO₂ adsorption occurs at low operating temperature (T<80° C.) while sorbent regeneration takes place at higher temperatures but also at relatively low temperatures (T>100° C.). For the complete regeneration of the sorbent in a sufficiently fast way it is enough to operate with temperatures of the order of 200° C.

Different patents describe processes and improvements to optimize the carbonation of Na₂CO₃, which is exothermic [3,4]. The management of this heat released in the reactor is essential to effectively implement the process in a commercial system minimizing the energy penalty of the process in which it is integrated.

On the other hand, there are different production processes for sodium bicarbonate, an intermediate solvent in the dry carbonate process. SOLVAY's patent for the production of sodium bicarbonate ES2409084 (A1) [5], describes a procedure for producing sodium bicarbonate from a stream carrying sodium carbonate, part of which is generated by a crystallizer, where that stream carries sodium carbonate (A) with at least 2% by weight of sodium chloride and/or sodium sulphate. The process includes an aqueous dissolution process, generation of sodium bicarbonate crystals and their separation. Patent US2015175434 (A1) [6] describes a process for the joint production of sodium bicarbonate and other alkaline compounds in which CO₂ is generated as an intermediate product that can be used to replenish the production phase of sodium bicarbonate.

Na₂CO₃ can be obtained from the decomposition of the natural mineral trona (Na₂CO₃-NaHCO₃-2H₂O), composed of sodium carbonate (Na₂CO₃) in approximately 46% and sodium bicarbonate (NaHCO₃) in 35% by weight and widely available. The region of the world with the highest production of this mineral is Wyoming (United States) whose mines produced more than 17 million tons of trona. The US Geological Survey in 1997 estimated that the total trona reserve is 127 million tonnes, although only 40 million tonnes are recoverable [7]. Trona is stable up to 57° C. dry, and creates intermediate compounds such as wegschiderite (Na₂CO₃-3NaHCO₃) and sodium monohydrate (Na₂CO₃— H₂O) between 57° C. and 160° C. [8]. Above 160° C., trona decomposes to Na₂CO₃ [9].

A relevant technological challenge is the development of a method for the conversion of the Na₂CO₃ fraction in the trona into a commercial value-added product such as sodium bicarbonate (NaHCO₃) that is profitable.

The generation of sodium bicarbonate from trona is described in different patents [10-11]. Patent US2013095011 (A1) [12] describes a process for the production of sodium carbonate and sodium bicarbonate from trona. It includes the grinding of the trona and its dissolution in a solution with sodium carbonate and an additive that generates solid particles suspended in the aqueous solution and that can be separated.

For the generation of sodium bicarbonate crystals from trona in WO2013106294 (A1) [13] a process for the production of sodium bicarbonate crystals from trona and water is described; US2011064637 (A1) [14] a process for the joint production of sodium carbonate and sodium bicarbonate crystals from sodium sesquicarbonate powder is described. The process uses a suspension of water and a gas containing CO₂. In US2009238740 (A1) [15] is presented a method of preparing sodium bicarbonate from trona containing sodium fluoride as impurity by preparing a trona solution and introducing CO₂ until the solution reaches a pH in the range of 7.5 to 8.75 precipitating the sodium carbonate in the trona solution. US2006182675 (A1) [16] contains a process for the production of bicarbonate obtained from trona including the stages of purification, evaporation-decarbonation, crystallization, centrifugation and drying. In US2004057892 (A1) [17] a method for producing sodium bicarbonate from trona ore is patented. The process uses the effluent water stream from the conversion of trona to sodium carbonate as a supply for the conversion of sodium carbonate to sodium bicarbonate.

The current state of the art for the production of NaHCO₃ from trona can be summarized as follows. A vertical tubular reactor with a perforated bottom that separates the upper fluidization chamber from a lower stagnation chamber is fed with ground natural trona. A stream of gas is passed through the stagnation chamber in upward direction through the perforated bottom into the fluidization chamber at a speed high enough to hold a portion of the load in suspension, and to carry away decomposition gases, such as steam and CO₂, that are generated during the reaction. The fluidized bed reactor acts both as a calciner for the trona and as a separator of the fine trona particles from the coarse portion of the load remaining suspended in the fluidized bed.

The thermal energy required to convert the raw material (trona) into raw sodium carbonate can be supplied by heating the fluidization gas or by placing internal heating devices or around the fluidized bed, preferably within the fluidized bed. The temperature of the fluidized bed must be in the range of 140°-220° C. [8]. The reaction that takes place in the fluidized bed reactor is:

$$2 {( {Na}_{2} {CO}_{3} \cdot {NaHCO}_{3} \cdot 2 {H}_{2} O )}_{( s )} -> 3 {Na}_{2} {CO}_{{3 }_{( s )}} + {CO}_{{2}_{( g )}} + 5 {H}_{2} {O}_{( g )} \\ Δ {H}_{298 K} = \text{133.9} \frac{KJ}{mol} \qquad [ 9 ]$$

For the production of sodium bicarbonate the intermediate Na₂CO₃ solution is centrifuged to separate the liquid from the crystals. The crystals are then dissolved in a carbonate solution (a solution of Na₂CO₃) in a rotating diluter, thus becoming a saturated solution. This solution is filtered to remove any insoluble material and then pumped through a feed tank to the top of a carbonation tower. The purified CO₂ is introduced into the lower part of the carbonation tower and remains pressurized. As the saturated sodium solution evolves through the carbonator, it cools and reacts with the CO₂ to form sodium bicarbonate crystals. These crystals are collected at the bottom of the reactor and transferred to another centrifuge, where the excess solution is separated by filtration. The crystals are then washed in a bicarbonate solution, forming a cake-like substance ready for drying in the filtrate. The filtrate removed from the centrifuge is recycled into the rotary dilution vessel, where it is used to saturate more intermediate Na₂CO₃ crystals. The washed filter cake is then dried either on a continuous belt conveyor or in a flash dryer.

In the carbonation tower, the saturated solution of Na₂CO₃ evolves from the top to the bottom. As it falls, the solution cools and reacts with the CO₂ to form NaHCO₃ crystals. After filtration, washing and drying, the crystals are sorted by particle size and packed properly. The reaction that takes place in the carbonation tower is:

$${Na}_{2} {CO}_{{3}_{( s )}} + {CO}_{{2}_{( g )}} + {H}_{2} {O}_{( g )} ↔ 2 {NaHCO}_{3} \\ Δ {H}_{298 K} = \text{129.09} \frac{kJ}{mol} \qquad [ 11 ]$$

The heat required in this endothermic process can be supplied by fossil fuels or renewable sources such as solar energy or biomass. Since the operating temperature is moderate (200° C.) a low cost parabolic trough (PTC) system could be used to supply the heat required for endothermic reactions. The parabolic trough concentrator (PTC) is a solar concentrator technology that converts solar radiation into thermal energy in the receiver by means of a linear focusing system. The applications of PTC parabolic trough systems can be divided into two main groups. The first and most developed is associated with concentrated solar power (CSP) plants for the generation of electricity using temperatures relatively around 300-400° C. The second group of applications is associated with the supply of thermal energy in applications that require temperatures in the range 85-250° C. The second group of applications is associated with the supply of thermal energy in applications that require temperatures in the range 85-250° C. The second group of applications is associated with the supply of thermal energy in applications that require temperatures in the range 85-250° C. These applications, which mainly use heat from industrial processes, can be cleaning, drying, evaporation, distillation, pasteurization, sterilization, among others, as well as applications with low temperature heat demand and high consumption rates (domestic hot water, heating, heated swimming pools), as well as heat-based cooling [18]. Currently the term medium temperature collectors is used to refer to collectors operating in the range of 80-250° C.

Regarding CO₂ capture systems with production of sodium bicarbonate, in US20100028241A1 [20] and WO2009029292A1 [21] there is a reaction system for partial carbon capture (CO₂ and CO) in coal plants and production of hydrogen and hydrogen compounds from sodium chloride NaCl, coal and water. Sodium hydroxide generated from chloride is used to produce sodium carbonate and bicarbonate. Chemical reactions between gases, hydroxide, carbon or natural gas produce solid carbonate and hydrogen, valuable substances that can be sold or used to generate electricity. WO2011075680A1 [22] describes a process by which CO₂ is absorbed by an aqueous caustic mixture and then reacted with hydroxide to form carbonate/bicarbonate. This involves the use of a liquid mixture separation process and the use of an electrolysis process. In patent US20060185985A1 [23] the same process of using hydroxide and electrolysis to obtain carbonate and bicarbonate from CO₂ captured by an aqueous mixture is presented. These aqueous CO₂ capture solutions are described in patent US20100051859A1 [24] in which water is processed to generate an acidic solution and an alkaline solution that captures the CO₂.

The invention presented in this document consists of the synergistic integration of: i) a CO₂ capture system based on the use of trona as a precursor of Na₂CO₃ that will be used as a CO₂ sorbent; ii) CO₂ capture of effluent gases through a dry carbonate capture process (dry carbonation process), therefore not based on aqueous solutions such as the above-mentioned patents; iii) production process of sodium bicarbonate as a product that can be partly reused in the capture process and the rest can be in other applications.

This synergistic integration of both processes has several advantages such as: i) energy consumption allows the integration with heat sources for sorbent regeneration based on renewable energies such as biomass or medium temperature solar energy (<220° C.); ii) sorbent: the bicarbonate produced in the process allows the regeneration of the raw material used in the CO₂ capture process while the excess of bicarbonate produced is a chemical product with economic value and whose sale could reduce the economic penalty of the plant; iii)) the proposed integration using as heat sources renewable energy (solar, biomass, wind) results in global systems of zero CO₂ emissions with a reduced penalty of the integrated system performance and with a low energy penalty.

### REFERENCES

[1] Spigarelli B P, Kawatra S K. Opportunities and challenges in carbon dioxide capture. J CO2 Util 2013; 1:69-87. doi:10.10164.jcou.2013.03.002.
[2] Nelson, T. O., Coleman, L. J., Green, D. A., & Gupta, R. P. (2009). The dry carbonate process: carbon dioxide recovery from power plant flue gas. Energy Procedia, 1(1), 1305-1311.
[3] Krieg, J. P., and Winston, A. E. 1984. Dry Carbonation Process. U.S. Pat. No. 4,459,272, assigned to Church & Dwight Ca, Inc., filed Apr. 26, 1983, and issued Jul. 10, 1984.
[4] Falotico, A. J. 1993. Dry Carbonation of Trona. PCT Application No.: PCT/US1992/006321 (WO1993/011070), assigned to Church & Dwight Company, Inc., June 10.
5] WALRAVENS HUGO; ALLEN KURT; CHAU THOI-DAI; VANDENDOREN ALAN, “PROCEDURE TO PRODUCE SODIUM BICARBONATE” Spanish Patent ES2409084 (A1),
6] KISIELEWSKI JAMES C; HANSEN DAVID M, PRODUCTION OF CRYSTALLINE SODIUM BICARBONATE USING CO2 RECOVERED FROM ANOTHER ALKALI PRODUCTION PROCESS U.S. Patent No. US2015175434 (A1)
[7] Harris R E. Fifty Years of Wyoming Trona Mining 1997:177-82.
[8] Gartner R S, Witkamp G J. Wet calcining of trona (sodium sesquicarbonate) and bicarbonate in a mixed solvent. J Cryst Growth 2002; 237:2199-204. doi:10.1016/S0022-0248(01)02275-8.
[9] Kim N K, Srivastava R, Lyon J. Simulation of an industrial rotary calciner with trona ore decomposition 2002.
[10] Sproul, Jared Sanford, and Eric Rau. “Process for producing sodium carbonate from trona.” U.S. Pat. No. 3,869,538. 4 Mar. 1975.
[11] Turner, Allan L. “Process for producing sodium carbonate from trona ore.” U.S. Pat. No. 6,010,672. 4 Jan. 2000.
12] BRETON CLAUDE; CHAU THOI-DAI; PIET JOFFREY, PROCESS FOR THE JOINT PRODUCTION OF SODIUM CARBONATE AND SODIUM BICARBONATE, U.S. Patent No. US2013095011 (A1)
13] BRACILOVIC DRAGOMIR M; KURTZ ANDREW D; PALUZZI JOSEPH A; SENK ZBIGNIEW M BOUNDARY LAYER CARBONATION OF TRONA, WO Patent No. WO2013106294 (A1)
14] DAVOINE PERRINE; COUSTRY FRANCIS M; DETOURNAY JEANPAUL; ALLEN KURT, PROCESS FOR THE JOINT PRODUCTION OF SODIUM CARBONATE AND SODIUM BICARBONATE, U.S. Patent No. US2011064637 (A1)
15] SENSARMA SOUMEN; PHADTARE SUMANT; SASTRY MURALI, METHOD OF REMOVING FLUORIDE IMPURITIES FROM TRONA AND PREPARATION OF SODIUM BICARBONATE, U.S. Patent No. US2009238740 (A1)
16] CEYLAN ISMAIL; UGURELLI ALI; DILEK NOYAN, PROCESS FOR PRODUCTION OF DENSE SODA, LIGHT SODA, SODIUM BICARBONATE AND SODIUM SILICATE FROM SOLUTIONS CONTAINING BICARBONATE, U.S. Patent No. US2006182675 (A1
17] KURTZ ANDREW D, SODIUM BICARBONATE PRODUCTION METHOD, U.S. Patent No. US2004057892 (A1)
[18] Fernandez-Garcia A, Zarza E, Valenzuela L, Perez M. Parabolic-trough solar collectors and their applications. Renew Sustain Energy Rev 2010; 14:1695-721.
[19] Hal B. H. Cooper Robert E. Tang Donald E. Degling Thomas K. Ewan Sam M. Ewan, Process and apparatus for carbon capture and elimination of multi-pollutants in fuel gas from hydrocarbon fuel sources and recovery of multiple by-products, U.S. Patent No. US20080250715A1
[20] Surendra Saxena, Hydrogen Production and Carbon Sequestration in Coal and Natural Gas-Burning Power Plants, U.S. Patent No. US20100028241A1
[21] Surendra Saxena, Hydrogen production with carbon sequestration in coal and/natural gas-burning power plants, WO Patent No. WO2009029292A1
22] Joe David Jones, Carbon dioxide sequestration by formation of Group 2 carbonates and silicon dioxide, WO Patent No. WO2011075680A1
[23] Joe Jones, Removing carbon dioxide from waste streams through co-generation of carbonate and/or bicarbonate minerals, U.S. Patent No. US20060185985A1
[24] Kurt Z. House Christopher H. House Michael J. Aziz Daniel Paul Schrag, Carbon Dioxide Capture and Related Processes, U.S. Patent No. US20100051859A1

### DESCRIPTION OF THE FIGURES

FIG. 1. Schematic representation of the invention with representation of the different solid and gas streams and interaction between the CO₂ capture and NaHCO₃ generation subsystems.

FIG. 2. Schematic representation of the CO₂ capture and storage subsystem using the dry carbonation process. The figure illustrates a possible configuration for the CO₂ capture subsystem. The different reaction processes units, heat exchange and product separation are shown.

| | Meaning |
|---|---|
| Components | |
| 1. | Power plant |
| 2. | Water-Flue gases heat exchanger |
| 3. | CO₂ capture reactor |
| 4. | Solid-gas separator |
| 5. | Heat exchanger NaHCO₃—Na₂CO₃ |
| 6. | Sorbent Regenerator |
| 7. | Solid-gas separator |
| 8. | CO₂ cooler (20° C.) |
| 9. | CO₂ compressor (1-10 bar) |
| 10. | CO₂ cooler (20° C.) |
| 11. | CO₂ compressor (10-25 bar) |
| 12. | CO₂ cooler (20° C.) |
| 13. | CO₂ compressor (25-75 bar) |
| 14. | CO₂ cooler (20° C.) |
| Flows | |
| F1. | Flue gases at the power plant exhaust |
| F2. | Water for the CO₂ capture reactor |
| F3. | Make-up of the sorbent needed in each cycle |
| F4. | Product at the exit of the carbonator |
| F5. | Flue gases at the exit of the carbonator |
| F6. | Solids at the carbonator outlet (60° C.) |
| F7. | Solids at regenerator input (140° C.) |
| F8. | CO₂ recovered from the system |
| F9. | Regenerated Na₂CO₃ (80° C.) |
| F10. | Regenerated Na₂CO₃ (200° C.) |
| F11. | CO₂ to the storage system (20° C., 75 bar) |

FIG. 3. Schematic representation of the sodium bicarbonate production subsystem. The figure illustrates a possible configuration for the production of NaHCO₃. Use of natural Trona mineral and CO₂ from the capture subsystem (CO2 EN). Excess Na2CO3 is sent to the capture subsystem for sorbent make-up. The different reaction processes units, heat exchange and product separation are shown.

| | Meaning |
|---|---|
| Components | |
| 15. | Heat exchanger Trona—Na₂CO₃ |
| 16. | Fluidized bed reactor |
| 17. | Solid-gas separator |
| 18. | Heat exchanger Water—Water + CO₂ |
| 19. | CO₂ capture and production reactor NaHCO₃ |
| 20. | Solid-liquid separator |
| Flows | |
| F12. | Crushed trona |
| F13. | Hot trona at fluidized bed reactor inlet (125° C.) |
| F14. | Product at the outlet of the fluidized bed reactor |
| F15. | CO₂ and steam (220° C.) |
| F16. | CO₂ and water (95° C.) |
| F17. | Water (35° C.) |
| F18. | Superheated steam (205° C.) |
| F19. | Na₂CO₃ hot (220° C.) |
| F20. | Na₂CO₃ cooled (40° C.) |
| F3. | Make up of the sorbent needed at each cycle |
| F21. | Product inlet to the NaHCO₃ production reactor |
| F11. | CO₂ capture system |
| F22. | Product at the exit of the NaHCO₃ production reactor. |
| F23. | Process water |
| F24. | NaHCO₃ system product |

### DETAILED DESCRIPTION OF THE INVENTION

The present invention refers to an integrated system of production of sodium bicarbonate (Na₂HCO₃) from CO₂ captured by a dry carbonation process from trona (Na₂CO₃—NaHCO₃-2H₂O) as raw material and converting it into sodium carbonate (Na₂CO₃). Part of Na₂CO₃ is recycled as sorbent in the CO₂ capture process and the rest is used together with part of the captured CO₂ for the production of sodium bicarbonate as a commercially valuable chemical.

The optimized integration of the system allows the coupling of a medium-temperature heat supply system, which can be based on medium-temperature solar thermal energy or on biomass, capable of satisfying the heat needs of the integrated unit, thereby minimizing the energy consumption of the CO₂ capture system and the production of bicarbonate. This optimized integration reduces the energy and, above all, the economic penalty of CO₂ capture. Depending on the configuration adopted, the thermal energy to be provided for CO₂ capture is of the order of 915 kWhth per ton of CO₂ captured, while the thermal energy consumption for the conversion of CO₂ to sodium bicarbonate would have a thermal energy consumption of the order of 250 kWhth per ton of NaHCO₃ produced. To these consumptions is added the energy consumption associated with the compression of CO₂ for storage, which in the case of an increase in pressure from atmospheric pressure to 75 bar is of the order of 112 kWhₑₗ per tonne of CO₂.

The proposed system is composed of two subsystems, one associated with the dry carbonation process for CO₂ capture, based on the use of sodium carbonate as a CO₂ sorbent and another related to the production of sodium bicarbonate from trona.

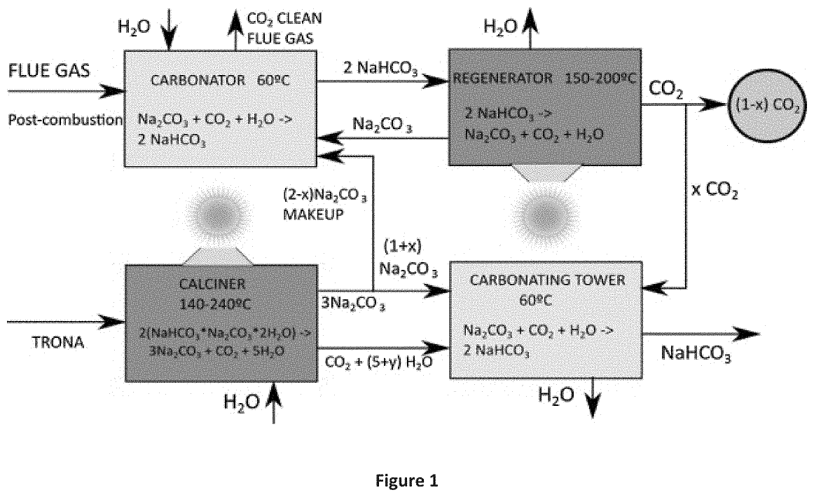

The conceptual scheme of the integrated system is shown in FIG. 1 that illustrates the logical structure of streams integration between both processes of capture and generation of sodium bicarbonate with part of the captured CO₂. The process also allows regeneration and control of the amount of captured CO₂ and recirculated Na₂CO₃ to optimize the mode of operation, energy consumption and economic return of the system as a whole.

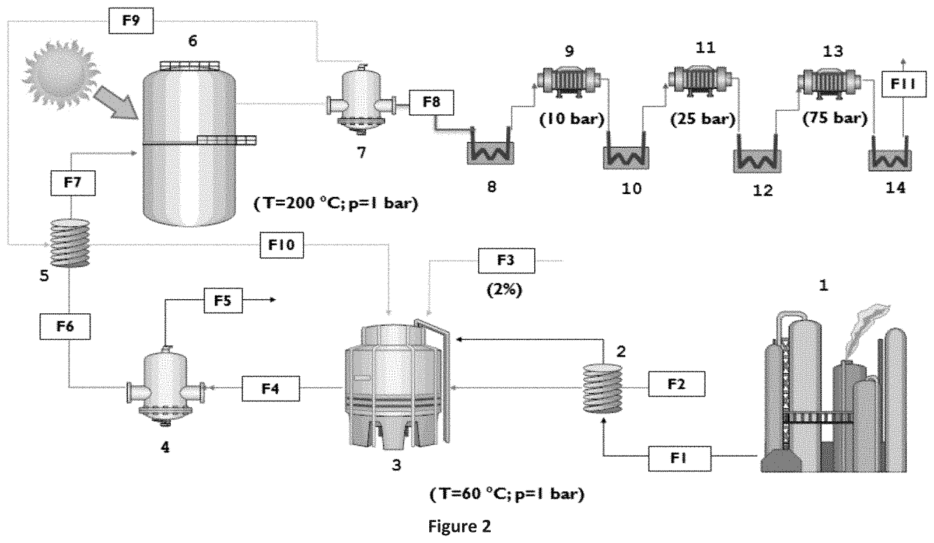

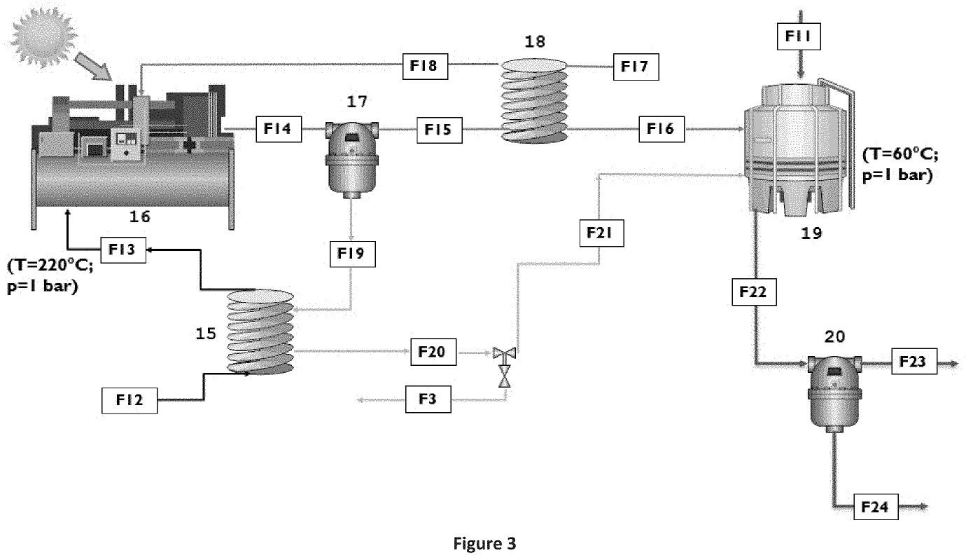

The main units of the first subsystem (CO₂ capture) are shown in FIG. 2. They are a CO₂ capture reactor (carbonator), a desorption reactor (regenerator), two separation units, heat exchangers for heat recovery, a water condensation unit at the end of the process and compressors for pure CO₂.

The elements that make up the second subsystem, conversion from CO₂ to sodium bicarbonate, (FIG. 3) use similar units: a fluid bed reactor for the conversion of trona into sodium carbonate, a carbonation tower for the production of sodium bicarbonate, two separation units and heat exchangers for heat recovery and energy optimization of the processes.

In the CO₂ capture subsystem (FIG. 2), combustion gases from a fossil fuel power plant or an industrial application are sent to the carbonation tower. In the carbonator, CO₂, H₂O and Na₂CO₃ react exothermically to form NaHCO₃. This reactor operates at low temperature (T=60° C.) and atmospheric pressure (p=1 atm), so the released heat can be used for low temperature thermal storage. The system integrates a separator that divides the bicarbonate solution stream from the residual flue gas stream. With this configuration 90% of CO₂ input can be captured. The outgoing bicarbonate stream is sent to a regenerator. In it, the inverse (endothermic) reaction takes place, leading to the formation of Na₂CO₃, H₂O and CO₂ from NaHCO₃. This heat can be supplied by a moderate temperature source of both fossil and renewable origin. In order not to introduce new CO₂ emissions from fossil fuels, heat can be supplied either from biomass or from solar energy by means of a system based on parabolic troughs that are particularly suitable for medium temperature (200° C.) operation. In the regenerator the output streams are separated: Na₂CO₃ is sent back to the carbonation tower, while the CO₂ not used in the generation of bicarbonate is sent to a stage of water condensation and subsequent compression for storage. Intermediate cooling is required to reduce the power required by the compression process. The system will need some sorbent to replace deactivated Na₂CO₃ with irreversible reactions associated with the SO₂ and HCl reaction normally present in flue gases.

The second subsystem (FIG. 2) uses a fraction of the CO₂ captured in the first subsystem and trona to produce NaHCO₃. Ground trona ore is introduced into the fluidized bed reactor along with superheated steam at 200° C. The fluidized bed reactor operates in the range of 200-220° C. and atmospheric pressure. Under these operating conditions the trona becomes Na₂CO₃. An additional flow of CO₂ and steam is generated during the conversion of the trona which is separated from the Na₂CO₃ flow. Part of the flow of Na₂CO₃ is sent to the capture subsystem by dry carbonate as a fresh replacement sorbent, while the rest is sent to a carbonation tower along with the CO₂ and H₂O stream, and additional pure CO₂ from the capture subsystem (FIG. 1) in order to produce NaHCO₃, a product with added value for the chemical industry and suitable for sale.

In the proposed invention CO₂ from fossil fuel power plants (coal, natural gas or fuel oil), or from industrial processes (refineries, cement plants, metallurgical industry, etc.) is captured through the dry carbonate process using as raw material a mineral abundant in nature and relatively low cost (trona ore).

The optimized integration of CO₂ capture and sodium bicarbonate production results in a synergistic configuration in terms of energy consumption and associated costs of CO₂ capture processes and conversion to high value-added chemical (sodium bicarbonate). The integration of both presents an energy penalty of the power plant (or CO₂ emitting industry to which it is applied) moderate compared to that it has with other CO₂ capture systems. This energy penalty is associated with the extra energy consumed in the processes. The heat supplied both in the sorbent regenerator in the CO₂ capture subsystem and in the fluidized bed reactor in the sodium bicarbonate production subsystem may originate from both fossil fuel, with the corresponding penalty in terms of additional CO₂ emissions and cost of operation, or from renewable sources that allow virtually zero CO₂ emissions. This can be achieved either by the use of biomass or by solar energy at medium temperature. In both cases and thanks to the optimization of subsystem integration made in this invention in terms of operating conditions and fraction of CO₂ captured in the exhaust gas used for the production of a chemical product with added value (NaHCO₃). In addition, the process itself generates the replacement sorbent for the capture process in the plant. Therefore there is a synergy of the integrated whole against the behaviour of the isolated systems. This translates into a clear energy, environmental and economic benefit from the integration of systems that cannot be expected from the analysis of their isolated behaviour and with a clear advantage over other capture systems (or CO₂ capture and use).

The CO₂ capture and storage subsystem shown in FIG. 2 uses a solid-solid heat exchanger (HEATEXCH) between the two reactors to reduce the total amount of heat required in the regenerator. This heat exchanger allows an increase of the temperatures in the regenerator, which improves the reaction speed, with a small additional expenditure of thermal energy. FIG. 3 shows the schematic of a possible configuration for sodium bicarbonate production. Before entering the fluidized bed reactor, the trona, under ambient conditions, passes through a solid-solid heat exchanger (HEATEXT) where it exchanges heat with the Na₂CO₃ stream leaving the fluidized bed reactor. Another heat exchanger (HEATEXVV) is used to heat the water entering the fluid bed from the gases coming out of it, which allows superheated steam to be supplied to the reactor.

The synergy obtained by integrating both systems is reflected in the flow diagram in FIG. 1.
For the production of NaHCO₃ from trona, the necessary CO₂ is supplied by the CO₂ capture subsystem (x*CO2 in the diagram). Therefore, part of the captured CO₂ is used and the rest is stored, giving rise to a new application of CCUS (Carbon Dioxide Capture, Utilization and Storage) not identified to date.
In order to capture CO₂ in the dry carbonate process, a contribution of fresh Na₂CO₃ is required, which with the proposed integration is supplied by the Trona production subsystem (MAKEUP in FIG. 1). This makes the CO₂ capture system substantially cheaper, which is novel.

The advantages of this technology are:
CO₂ capture technology in fossil fuel thermal plants and in industrial plants with reduced energy and economic penalties of the whole system.
CO₂ capture technology and conversion to chemical product with added value, sodium bicarbonate, both for thermal fossil fuel plants and for other CO₂ emitting industrial plants with a significant economic return because the effect of energy penalty is supplemented by the sale of NaHCO₃. It also generates the amount of fresh sorbent that needs to be replenished due to its deactivation.
A fraction of the captured CO₂ is integrated into the production of sodium bicarbonate, which reduces/eliminates storage requirements. This increases the sustainability of the CO₂ capture process.
In the case of integration of renewable energy source (biomass or solar medium temperature) a global system of almost zero CO₂ emissions is obtained both for fossil fuel power plants and for other industrial plants. It includes industrial sectors such as coal, steel, cement.
It allows optimizing the configuration of the integration and the fraction of recirculated Na₂CO₃ and stored CO₂ in the form of bicarbonate according to the production requirements from the environmental point of view according to the characteristics of the integration.
It can be incorporated into existing thermal and industrial plants without any relevant penalty for their performance.

### Example of the Invention

As an example of the invention, the process of producing sodium bicarbonate using CO₂ captured by a dry carbonation process in a coal-fired power plant (150 MWel) is shown. The combustion gases of the plant have a concentration of CO₂ (˜15% vol). The main data for the coal-fired power plant are shown in Table 1.

TABLE 1
Data from the invention example. Reference thermal power station.
150 MWel coal plant

| Item | Magnitude | Units |
|---|---|---|
| Coal consumption | 61 | ton/hr |
| Air Flow | 692 | ton/hr |
| Gross input power | 447 | MWₜₕ |
| Net input power | 397 | MWₜₕ |
| Net power produced | 150 | MWₑₗ |
| Net yield | 33.5 | % |

Table 2 shows the molar fluxes of the combustion gases taken to illustrate the invention.

TABLE 2
Composition of the exhaust gases in the reference coal-fired power plant

| Compound at the output | Mole flow | Mass expenditure |
|---|---|---|
| stream | (kmol/hr) | (tons/hr) |
| N2 | 17154.21 | 529.71 |
| CO₂ | 3085.62 | 135.96 |
| H2O | 1471.86 | 29.4 |
| O2 | 781.8 | 27.57 |
| CO | 140.7 | 3.93 |
| NO | 135.36 | 4.47 |
| SO | 37.53 | 2.64 |

Other parameters used in the analysis are shown in Table 3 while Table 4 shows the energy consumption associated with the different components.

TABLE 3
Reference parameters for the invention example

| Regenerator temperature | 200° | C. |
|---|---|---|
| Fluidized Bed Reactor Temperature | 220° | C. |
| Carbonation Temperature and | 60° | C. |
| Na₂CO₃ Activity | 0.75 | |
| Minimal temperature difference in heat exchangers | 15° | C. |
| Transport consumption of solids | 5.5 | kwhₑₗ/tn |
| Reference solar hours | 12 | |
| Isentropic performance of compressors | 0.9 | |
| _{CO2} storage pressure | 75 | bar |

TABLE 4
Energy consumption in the reference plant of the invention example
with the CO₂ capture system and production of NaHCO₃.

| | Generated power | | Power consumption | |
|---|---|---|---|---|
| CFFP | 150 | MWₑₗ | 447 | MWₜₕ |

| | | |
|---|---|---|
| Regenerating Heat | 114 | MWₜₕ |
| CO₂ compression power | 13.3 | MWₑₗ |
| Power for transport of solids | 2.47 | MWₑₗ |

| | | |
|---|---|---|
| Net power | 134.23 | MWₑₗ |

| | | |
|---|---|---|
| Fluidized Bed Reactors | 51 | MWₜₕ |
| Total heat required | 612 | MWₜₕ |

The capture subsystem has a yield of 90%. It uses 430 tons/hr of Na₂CO₃ as a sorbent to remove 125 tons/hr of CO₂ in a continuous cycle. The replacement sorbent flow is close to 3 ton/hr. As shown in Table 4, the heat required for sorbent regeneration after CO₂ capture is 114 MWₜₕ. The energy consumption for the compression of CO₂ and the transport of solids amounts to 16 MWₑₗ. The total efficiency of the integrated plant (coal combustion plant+capture) considering the required heat input the power consumed is reduced from 33.5% to 24%. Considering only the effect of the power required for compression and transport, for this example the reduction in the available electrical energy is 10% which has an effect on the overall efficiency of 3%. Considering that the temperatures in the reactors allow the integration of solar energy input, the whole system could operate with a penalty on the economic performance (available energy/purchased energy) lower than 3% achieving almost zero emissions.

In the NaHCO₃ production subsystem (FIG. 3), the heat required in the fluidized bed reactor to decompose 192 ton/hr (53.3 kg/sec) of trona is 51 MWth at T=220° C. to produce 135.5 ton/hr of Na₂CO₃ (plus 18.5 ton/hr of CO₂ and 40 ton/hr of water). As a replacement sorbent for the CO₂ capture process 3 to/h of Na₂CO₃ are used. The rest, (132.5 ton/hr) is sent to the carbonation tower where it reacts with 37.5 ton/hr of CO₂ from the CO₂ capture system (in addition to CO₂ effluent from the fluidized bed) to produce NaHCO₃. From the reaction Na₂CO₃+H₂O+CO₂→2NaHCO₃ it results that 207.5 ton/hr of NaHCO₃ are produced with a total flow of approximately 95 m³/hr. In this way, a chemical product of high economic value (NaHCO₃) is obtained from a relatively low-cost and abundant raw material such as trona and from part of the captured CO₂ (from thermal power stations or industrial processes). This integrated process of capture and conversion to NaHCO₃ reduces (and eliminates depending on the mode of operation chosen) the need for total storage of CO₂, with the requirements of compression system and energy penalty that entails.

The overall performance of the system, and the available/required electrical power is reduced by the integration of the production of sodium bicarbonate, which in turn captures CO₂ that does not need to be compressed. The economic income associated with the new product compensates for the penalty associated with this process. The total heat requirements are increased by taking into account the 51 MW thermal required in the fluidized bed reactor.

1. Integrated CO₂ capture system and production of sodium bicarbonate (Na₂HCO₃) characterized by the integration of:
a. CO₂ capture through a dry carbonation process
b. Conversion of trona (Na₂CO₃—NaHCO₃-2H₂O) into sodium carbonate (Na₂CO₃)
c. Generation of sodium bicarbonate from the Na₂CO₃ generated and the CO₂ captured.

2. Integrated CO₂ capture system and NaHCO₃ generation according to claim 1 wherein it is integrated in the output current of fossil fuel thermal plants and in CO₂ emitting industrial installations.

3. Integrated system of CO₂ capture and generation of NaHCO₃ according to claim 1 wherein the subsystem of CO₂ capture uses the dry carbonation process.

4. Integrated system according to the claim 1 wherein the contribution of heat at medium temperature (140-230° C.) for the regeneration of sorbent and dissociation of the trona in the process of CO₂ capture can come from renewable energy, solar thermal technology of medium temperature or biomass.

5. Integrated system of CO₂ capture and generation of NaHCO₃ according to claim 1 wherein it allows generating near-zero CO₂ emissions systems, with an efficiency of capture above 90% in technologies based on fossil fuel, through the support of renewable energies. For coal plants the additional heat required is of the order of 10% of the total heat supplied to the global system.

6. Integrated CO₂ capture system and generation of NaHCO₃ according to claim 1 wherein the required CO₂ for the production of NaHCO₃ from Trona is supplied by the CO₂ capture subsystem.

7. Integrated CO₂ capture system and NaHCO₃ generation according to claim 6 wherein the CO₂ needed for the production of sodium bicarbonate comes from the captured CO₂ and in turn the conversion to sodium bicarbonate permanently fixes the captured CO₂.

8. Integrated system of CO₂ capture and generation of NaHCO₃ according to claim 1 wherein it internally generates the fresh sorbent (Na₂CO₃) that must be replaced to keep the CO₂ capture process active and allows the generation of the Na₂CO₃ needed in the make up for the dry carbonation process from the calcination of the trona to produce bicarbonate.

9. Integrated CO₂ capture system and NaHCO₃ generation according to claim 1 wherein it reduces the energy requirements of the whole integrated system due to the composition and temperature of the streams in sodium carbonate regenerator in the process of CO₂ capture and trona calciner (150-220° C.), and in both carbonation towers (60° C.).

10. A process for using the integrated CO₂ capture system and production of sodium bicarbonate (Na₂HCO₃) according to claim 1 comprising integrating the following:
a. capturing CO₂ through a dry carbonation process;
b. Converting trona (Na₂CO₃—NaHCO₃-2H₂O) into sodium carbonate (Na₂CO₃); and
c. Generating sodium bicarbonate from the Na₂CO₃ generated and the CO₂ captured.

11. The process according to claim 10, wherein the process is integrated in the output current of fossil fuel thermal plants and in CO₂ emitting industrial installations.

12. The process according to claim 10, wherein the subsystem of CO₂ capture uses the dry carbonation process.

13. The process according to claim 10, wherein the contribution of heat at medium temperature (140-230° C.) for the regeneration of sorbent and dissociation of the trona in the process of CO₂ capture can come from renewable energy, solar thermal technology of medium temperature or biomass.

14. The process according to claim 10, wherein the process allows generating near-zero CO₂ emissions systems, with an efficiency of capture above 90% in technologies based on fossil fuel, through the support of renewable energies. For coal plants the additional heat required is of the order of 10% of the total heat supplied to the global system.

15. The process according to claim 10, wherein the required CO₂ for the production of NaHCO₃ from Trona is supplied by the CO₂ capture subsystem.

16. The process according to claim 10, wherein the CO₂ needed for the production of sodium bicarbonate comes from the captured CO₂ and in turn the conversion to sodium bicarbonate permanently fixes the captured CO₂.

17. The process according to claim 10, wherein the process internally generates the fresh sorbent (Na₂CO₃) that must be replaced to keep the CO₂ capture process active and allows the generation of the Na₂CO₃ needed in the make up for the dry carbonation process from the calcination of the trona to produce bicarbonate.

18. The process according to claim 10, wherein the process reduces the energy requirements of the whole integrated system due to the composition and temperature of the streams in sodium carbonate regenerator in the process of CO₂ capture and trona calciner (150-220° C.), and in both carbonation towers (60° C.).
